(19) United States
(12) Patent Application Publication
(10) Pub. No.: US 2015/0068844 A1
(43) Pub. Date: Mar. 12, 2015

(54) SYSTEM & METHOD

(71) Applicants: Ingemar Strandell, Savedalen (SE); Frank Fiddelaers, Gorinchem (NL)

(72) Inventors: Ingemar Strandell, Savedalen (SE); Frank Fiddelaers, Gorinchem (NL)

(21) Appl. No.: 14/370,382

(22) PCT Filed: Dec. 17, 2012
(86) PCT No.: PCT/SE2012/000205

§ 371 Date: Jul. 2, 2014

(30) Foreign Application Priority Data
Jan. 2, 2012 (SE) 1200011-3

(51) Int. Cl. F16N 29/02

(52) U.S. Cl. CPC F16N 29/02
USPC 184/6.1

(57) ABSTRACT

A system for re-lubricating a machine element, which comprises an analysis device arranged to determine which part of a lubricant that is being used to lubricate the machine element has been depleted and to generate a signal indicative thereof. A lubrication element is arranged to automatically re-lubricate the machine element only with the part of the lubricant that has been depleted in response to the signal.

### CROSS REFERENCE TO RELATED APPLICATION

This is a National Stage application claiming the benefit of International Application Number PCT/SE2012/000205 filed on 17 Dec. 2012, which claims the benefit of Sweden Patent Application 1200011-3 filed on 2 Jan. 2012, both of which are incorporated herein by reference in their entireties.

### TECHNICAL FIELD

The present invention concerns a system and method for re-lubricating at least one machine element.

### BACKGROUND OF THE INVENTION

An automatic lubrication system, often referred to as a centralized lubrication system, generally comprises a controller or timer, a pump and lubricant reservoir, metering valves and fittings, and supply and feed lines. It typically delivers a controlled amount of lubricant, such as grease or oil, to one or more specific locations in a machine while the machine is operating, at specific times from a central location.

The term grease, in the context of lubrication, is used to describe a semi-solid lubricant consisting of a thickener, typically a soap, emulsified with mineral or vegetable oil and/or other fluid lubricant. Grease possesses a high initial viscosity, which upon the application of shear, drops to give the effect of oil lubrication of approximately the same viscosity as the base oil used in the grease. Greases are applied to machine elements that can only be lubricated infrequently and where a lubricating oil would not stay in position.

Grease also protects the machine elements that it lubricates against corrosion and wear, it helps to dissipate heat, seal out solid and liquid contamination, and reduces noise. Adequate lubrication allows for smooth continuous operation of equipment, with only mild wear, and without excessive stresses or seizures at components such as bearings. When lubrication fails, components can rub destructively over each other, causing damage, heat, and failure. Lubrication failure can be caused by insufficient lubricant quantity or viscosity, deterioration due to prolonged service without replenishment, excessive temperatures, contamination with foreign matter, the use of an incorrect grease for a particular application and/or over-lubricating.

To ensure that a machine element is correctly lubricated, the grease used has to be precisely selected for the particular application and applied in the right amount, at the right frequency and to the right place(s) in the machine elements. Factors influencing the choice of grease for a bearing application for example, include the bearing's rotational speed, service temperature range, running noise requirements, re-lubrication intervals, sealing, starting torque, load and running conditions and environmental influences.

Over time, the grease may leak, evaporate and/or harden. Oil may be depleted from the grease leaving a thick waxy substance with little or no ability to lubricate. New grease may be applied, however, to prevent premature wear and damage, manufacturers recommend that old grease is removed and replaced with new grease on a periodic basis, which can be a complex and time consuming process since it often requires equipment to be dismantled and carefully cleaned.

### SUMMARY OF THE INVENTION

An object of the invention is to overcome or ameliorate at least one of the disadvantages of the prior art, or to provide a useful alternative.

At least one of these objects is achieved by a system for re-lubricating a machine element which comprises analysis means arranged to determine which part of a lubricant, such as grease or oil, that is being used to lubricate the machine element has been depleted and to generate a signal indicative thereof, and lubrication means arranged to automatically re-lubricate the machine element only with the part of the lubricant that has been depleted in response to the signal. Only the required amount of the required lubricant part will thereby be applied to the machine element and/or added to the lubricant being used to lubricate the machine element, rather than applying/adding more of the entire lubricant.

For example, if grease is being used to lubricate a machine element and the analysis means of the system according to the present invention determines that a certain amount of fluid lubricant has become depleted, that amount of fluid lubricant will automatically be applied to the machine element and/or added to the lubricant lubricating the machine element by the lubrication means. Re-lubrication of a machine element is thereby much simpler since old grease does not have to be removed from a machine element and the amount of waste grease is reduced since the grease's thickener is re-used.

The expression “analysis means arranged to determine which part of a lubricant that is being used to lubricate the machine element has been depleted” is intended to mean that that the analysis means is arranged to determine, by calculation and/or measurement for example, which part of a lubricant has already been depleted, and/or which part of the lubricant being used to lubricate the machine element will be depleted at the next, or a subsequent re-lubrication time, i.e. the analysis means is arranged to determine how much of a certain part of a lubricant should be used to re-lubricate the machine element at the next, or a subsequent re-lubrication time based on how much of a certain part of the lubricant has been depleted and/or based on the rate at which a certain part of the lubricant is being depleted.

The expression “automatically re-lubricate” is intended to mean that the re-lubrication is not carried out manually by a human being, but by a self-acting and/or self-regulating mechanism or machine.

The analysis means may comprise one or more sensors that is/are arranged to determine which part of a lubricant that is being used to lubricate the machine element has been depleted and/or the rate at which it is being depleted. Such sensors may comprise at least one of the following: a visual inspection sensor, a temperature sensor, lubrication level sensor, electrical impedance sensor, ultrasonic instrumentation or any sensor arranged to measure a physical or chemical property of the lubricant being used to lubricate the machine element.

According to an embodiment of the invention the analysis means is also arranged to determine the condition of the machine element and/or condition of the lubricant being used to lubricate the machine element, and modify/exchange the composition of the lubricant being used to lubricate the element to a new lubricant, whereby the lubrication means is arranged to automatically apply and/or add components of the new lubricant which are not present in the lubricant being used to lubricate the machine element. According to another embodiment of the invention the lubrication means is arranged to subsequently automatically re-lubricate the machine element only with the part of the new lubricant that has been depleted.

Factors influencing the choice of lubricant for a machine element, may include the machine element's rotational speed, service temperature range, running noise requirements, re-lubrication intervals, sealing, starting torque, load and running conditions and environmental influences. If one or more of these factors change during the use of the machine element, it may be appropriate to modify/exchange the lubricant being used to lubricate the machine element at least in part and/or at least temporarily. A new lubricant having a different chemical composition and/or different chemical and/or physical properties than the lubricant being used to lubricate the machine element may namely be more suitable as re-lubrication after a change in the condition of the machine element and/or condition of the lubricant being used to lubricate the machine element.

According to an embodiment of the invention the analysis means is arranged to operate periodically. Additionally or alternatively, the analysis means is arranged to operate on request by a user.

It should be noted that the analysis means and/or lubrication means is/are arranged to operate when a machine component is in operation and/or when a machine component is not in operation.

According to another embodiment of the invention the part of the lubricant or the part of the new lubricant which has been depleted and is subsequently applied to the machine element comprises of a fluid lubricant, such as mineral oil, synthetic oil and/or vegetable oil, a polyalphaolefin, an ester, a polyether.

According to a further embodiment of the invention the part of the lubricant or the part of the new lubricant which has been depleted and is subsequently applied to the machine element comprises at least one of the following: a tackifier, an elastomer, an anti-wear additive, an anti-corrosion additive, an EP additive, an anti-oxidant. Some greases are labeled “EP”, which indicates “extreme pressure”. Under high pressure or shock loading, normal grease can be compressed to the extent that the greased parts come into physical contact, causing friction and wear. EP grease contains solid lubricants, usually graphite and/or molybdenum disulfide, to provide protection under heavy loadings. The solid lubricants bond to the surface of metal components, and prevent metal-to-metal contact and the resulting friction and wear when the lubricant film gets too thin.

Teflon may for example be added to improve the lubricating properties of the lubricant. Glycerol and sorbitan esters may be added to lubricant that is intended to be used in low temperature conditions. Copper may be added to lubricant intended for a high pressure applications.

According to an embodiment of the invention the lubricant comprises a thickener comprising at least one polyolefin component, for example comprising polyethylene or polypropylene or mixtures of these substances, at least one fluid lubricant component such as mineral oil, vegetable oil, synthetic oil-like polyalphaolefins, esters or polyethers, and at least one additive component which is selected from the group antioxidants, corrosion inhibitors, anti-wear agents or extreme pressure/load carrying capacity increasing additives. The content of the thickener component(s) may be between 5% and 30% by weight, preferably between 9 and 15% by weight, the content of the fluid lubricant(s) is between 60% and 90% by weight and the additive component(s) by weight between 0.2 and 15%, preferably between 1 and 8% by weight.

According to an embodiment of the invention the lubricant comprises a high molecular weight component and a low molecular weight component. For example, the thickener may comprise a mixture of a) a (co- or homo-)polymer of propylene with a weight average molecular weight greater than 200,000 and (b) a (co- or homo-)polymer of propylene with a weight average molecular weight less than 100,000. The ratio between the high molecular weight component and the low molecular weight component may be 1:40-1:5, preferably 1:25-1:15, more preferably 1:19. The low molecular weight component may be a polypropylene homopolymer. The low molecular weight component may have an average molecular weight between 50,000 and 100,000 with a melt flow rate (ASTM D-1238) of 500-1000, preferably 750-850. The high molecular weight component may be a polypropylene homopolymer or a propylene/ethylene-copolymer. The high molecular weight component may have an average molecular weight of 200,000-250,000 and a melt flow rate (ASTM D-1238) of 1.5-15, preferably 1.5-7.

According to another embodiment of the invention the lubricant comprises a mineral oil, at least one of the following: a thickening agent, oil-soluble polypropylene, oil-soluble propylene or mineral, metal soaps (soap-salt thickener), oil-soluble polypropylene, oil-soluble propylene or amorphous polyolefine polymers or semicrystalline polyolefine polymers e.g. isotactic or atactic polyolefin polymers.

Esters can effect solubility and boost oil-solubility of additives and thickening agents like polymers. Esters may be derived from carboxylic acids, branched, unbranched, straight or with cyclic alkyl group, aryl, alkaryl or aralkyl group group with 1-30 carbons, cyclic fatty esters, alkyl esters, saturated and unsaturated esters, diesters (from dicarboxylic organic compounds), disebacic acide esters, polyol esters, synthetic esters, phthalate esters, carboxylic acid esters. Alkylated napthlenes may be used as a synthetic fluid lubricant.

According to an embodiment of the invention the lubricant may comprise a paraffin based wax of a carbon chain length up to C40, either in pure form or in mixtures of different alkenes, or mixed with other polyolefin polymers (polyethylene) or ester waxes like cetyl myristoleate esters or cetyl palmitate esters. Waxes are natural, organic compounds that characteristically consist of long alkyl chains.

According to an embodiment of the invention the machine element is at least part of a one of the following: a shaft, coupling, key, spline, gear, fastener, spring, seal, belt, clutch, brake, chain, or a bearing element, such as a ball bearing, a roller bearing, a needle bearing, a tapered roller bearing, a spherical roller bearing, a toroidal roller bearing, a ball thrust bearing, a roller thrust bearing, a tapered roller thrust bearing, a wheel bearing, a hub bearing unit, a slewing bearing, a ball screw, or a component for an application in which it is subjected to alternating Hertzian stresses, such as rolling contact or combined rolling and sliding and/or an application that requires high wear resistance and/or increased fatigue and tensile strength.

The present invention also concerns a method for re-lubricating a machine element, which comprises the steps of determining which part of a lubricant that is being used to lubricate the machine element has been depleted and generating a signal indicative thereof, and automatically re-lubricating the machine element only with the part of the lubricant that has been depleted in response to the signal. A system according to any of the embodiments of the present invention may be used to carry out a method according to an embodiment of the present invention.

It should be noted that a system and/or a method according to the present invention may be used to re-lubricate at least one machine element. A plurality of machine elements (of one or more machines) may namely be re-lubricated simultaneously or at different times. It should be noted that any number of a plurality of machine elements may be re-lubricated in the same way (i.e. by applying or adding the same part of the lubricant that has been depleted to that number of the machine element in the same amount, and optionally at the same time), or each or a plurality of a plurality of machine elements may be re-lubricated in a way specific to that/those machine element(s). If a plurality of machine elements is to be re-lubricated in the same way, the determination of which part of the lubricant that is being used to lubricate those machine elements has been depleted may be carried out at at least one point in/on a machine element or in the lubrication system lubricating the machine element.

The system and method according to the present invention are particularly, but not exclusively, suitable for use with large size machine elements, and/or machine elements used in high speed or low temperature applications.

According to an embodiment of the invention, the system may comprise storage means arranged to collect and store information, such as information concerning the lubricant used to lubricate at least one machine element during its operation and the parts depleted from and added to the lubricant. Such information may be analyzed to improve the lubrication of the least one machine element, or a similar system.

Further embodiments of the method according to the present invention are recited in the dependent method claims.

### BRIEF DESCRIPTION OF THE DRAWINGS

The present invention will hereinafter be further explained by means of non-limiting examples with reference to the appended figures where;

FIG. 1 shows a bearing that is re-lubricated using a system or method according to an embodiment of the invention, and

FIG. 2 shows the steps of a method according to an embodiment of the invention.

It should be noted that the drawings have not been drawn to scale and that the dimensions of certain features have been exaggerated for the sake of clarity.

### DETAILED DESCRIPTION OF EMBODIMENTS

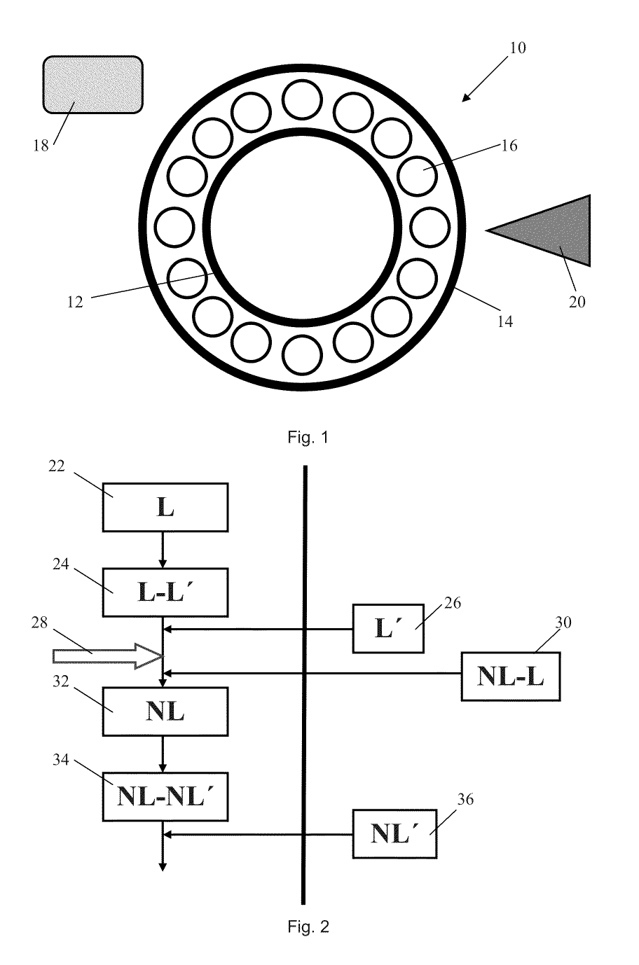

FIG. 1 schematically shows an example of a bearing 10, namely a rolling element bearing, that may range in size from 10 mm in diameter to a few metres in diameter and have a load-carrying capacity from a few tens of grams to many thousands of tonnes. The bearing element 10 may namely be of any size and have any load-carrying capacity. The bearing element 10 has an inner ring 12, an outer ring 14 and a set of rolling elements 16.

Prior to the use of the bearing 10, a suitable lubricant, such as grease, is applied between the rolling elements 16 and the inner ring 12 and outer ring 14 to lubricate the bearing 10. The grease may for example comprise a thickener, such as at least one of the following: a polymeric thickener, polypropylene, polyethylene, polyalkylene glycol, polyethylene glycol, polyolefin phenol, lanolin, lanoline polyethylene glycol, polyoxyethylene lanolin, silicon oil, ionic soap, urea soap, metal organic soap. The thickener may for example comprise polypropylene having both molecules of a high molecular weight and molecules of a low molecular weight. The grease may also comprise a fluid lubricant comprising at least one of the following: mineral oil, synthetic oil and/or vegetable oil. The grease may for example comprise 60-90% of the fluid lubricant. For example, the optimum grease for the application in which the rolling element bearing 10 is to be used comprises 85% mineral oil and 15% soap.

During the use of the bearing 10, analysis means 18, comprising at least one sensor and at least one computer or processor for example, is arranged to determine which part of the grease that is being used to lubricate said bearing 10 has been depleted and to generate a signal indicative thereof. For example, one or more sensors of an analysis means 18 may determine that the grease composition in or around the bearing 10 has changed during the use of the bearing and for example comprises 70% mineral oil and 30% soap, i.e. mineral oil has been depleted. A signal indicative of this may be transmitted to lubrication means 20 by wired or wireless means. The lubrication means 20 is arranged to add a determined amount of mineral oil so that the composition of the grease returns to 85% mineral oil and 15% soap, in response to the signal.

The depleted part of a lubricant may be applied to a single point, area or volume of a machine element 10 and/or added to the lubricant in the lubricant system lubricating the machine element 10, or to a plurality of points, areas or volumes. The lubricant may for example be sprayed onto at least one part of a machine element 10, and/or added to a reservoir containing lubricant.

Furthermore, a sensor of the analysis means 18 may also be arranged to determine whether there is an increased amount of iron in the lubricant being used to lubricate the bearing, indicative of rust in some part of the machine comprising the bearing element 10. A signal indicative of this may consequently be generated, whereupon the lubricating means 20 adds a determined amount of an anti-corrosion additive.

It should be noted that on determination of a machine condition, such as rusting in some part of a machine, the system according to the present invention may be arranged to apply and/or add a pre-determined amount of at least one additive to the lubricant being used to lubricate a machine element of that machine periodically or on demand.

It should be noted that a system according to the present invention may constitute an integral or separate part of an automatic lubrication system. The system according to the present invention and/or the automatic lubrication system may comprise a controller/timer that activates the system, a pump & reservoir that stores and provides lubricant, a supply line through which the lubricant is pumped which connects the pump to metering valves and/or injectors that measure/dispense the lubricant to one or more application points and a feed line that connects the metering valves and/or injectors to the one or more application points.

FIG. 2 shows the steps of a method for re-lubricating a machine element according to an embodiment of the invention. In the illustrated embodiment at least one machine element is being lubricated with lubricant L in step 22. Analysis means may then detect that a part L′ of the lubricant L has been depleted at step 24 whereupon a signal indicative thereof is generated. In step 26 the depleted part L′ of the lubricant is automatically added to the lubricant (L-L′) lubricating the machine element in an amount necessary to return the composition of the lubricant to its initial composition L in response to the signal.

At step 28, analysis means may determine a change in the condition of the machine element and/or condition of said lubricant being used to lubricate the machine element. The lubricant L being used to lubricate the machine element may then be modified/exchanged to a new lubricant NL at step 30 by automatically adding components of the new lubricant NL which are not present in the lubricant L being used to lubricate the machine element to the lubricant lubricating the machine element. The machine element is then lubricated by the new lubricant NL (step 32). If analysis means subsequently determines that a part NL′ of the new lubricant NL has been depleted during the use of the machine element (step 34) a signal indicative thereof is generated. In step 36 the depleted part L′ of the lubricant is automatically added to the lubricant (NL-NL′) lubricating the machine element in an amount necessary to return the composition of the lubricant to its initial composition NL in response to the signal.

A method according to an embodiment of the present invention may be carried out periodically and/or on request by a user.

Further modifications of the invention within the scope of the claims will be apparent to a skilled person.

1. A system for re-lubricating a machine element, the system comprising:
an analysis element arranged to determine which part of a lubricant that is being used to lubricate the machine element has been depleted and to generate a signal indicative thereof, and
a lubrication element arranged to automatically re-lubricate the machine element only with the part of the lubricant that has been depleted in response to the signal.

2. The system according to claim 1, wherein the analysis element is also arranged to determine at least one of a condition of the machine element and a condition of the lubricant being used to lubricate the machine element, and at least one of modifying and exchanging the lubricant being used to lubricate the machine element to a new lubricant, whereby the lubrication element is arranged to automatically add components of a new lubricant which are not present in the lubricant being used to lubricate the machine element.

3. The system according to claim 2, wherein the lubrication element is arranged to subsequently automatically re-lubricate the machine element only with the part of the new lubricant that has been depleted.

4. The system according to claim 1, wherein the analysis element is arranged to operate periodically.

5. The system according to claim 1, wherein the analysis element is arranged to operate on request by a user.

6. The system according to claim 1, wherein the part of the lubricant or the part of a new lubricant comprises at least one of the following: a tackifier, an elastomer, an anti-wear additive, an anti-corrosion additive, an EP additive, and an anti-oxidant.

7. The system according to claim 1, wherein the machine element is at least part of a one of the following: a shaft, a coupling, a key, a spline, a gear, a fastener, a spring, a seal, a belt, a clutch, a brake, a chain, a bearing element, a ball bearing, a roller bearing, a needle bearing, a tapered roller bearing, a spherical roller bearing, a toroidal roller bearing, a ball thrust bearing, a roller thrust bearing, a tapered roller thrust bearing, a wheel bearing, a hub bearing unit, a slewing bearing, a ball screw, or a component for an application in which it the component is subjected to alternating Hertzian stresses, including at least one of a rolling contact, a combined rolling and sliding, and an application that requires at least one of a high wear resistance, an increased fatigue, and tensile strength.

8. A method for re-lubricating a machine element, comprising steps of:
determining which part of a lubricant that is being used to lubricate the machine element has been depleted and generating a signal indicative thereof, and
automatically re-lubricating the machine element only with the part of the lubricant that has been depleted in response to the signal.

9. The method according to claim 8, further comprising steps of:
determining at least one of a condition of the machine element and a condition of the lubricant being used to lubricate the machine element,
at least one of modifying and exchanging the lubricant being used to lubricate the machine element to a new lubricant, and
automatically adding components of a new lubricant which are not present in the lubricant being used to lubricate said machine element.

10. The method according to claim 9, further comprising a step of subsequently automatically re-lubricating said machine element only with said part of said new lubricant that has been depleted during the use of said machine element.

11. The method according to claim 8, wherein the method it is carried out periodically.

12. The method according to claim 8, wherein the method is carried out on request by a user.

13. The method according to claim 8, wherein the part of the lubricant or the part of a new lubricant comprises at least one of the following: a tackifier, an elastomer, an anti-wear additive, an anti-corrosion additive, an EP additive, and an anti-oxidant.

14. The method according to claim 8, wherein the machine element is at least part of a one of the following: a shaft, a coupling, a key, a spline, a gear, a fastener, a spring, a seal, a belt, a clutch, a brake, a chain, a bearing element, a ball bearing, a roller bearing, a needle bearing, a tapered roller bearing, a spherical roller bearing, a toroidal roller bearing, a ball thrust bearing, a roller thrust bearing, a tapered roller thrust bearing, a wheel bearing, a hub bearing unit, a slewing bearing, a ball screw, or a component for an application in which the component is subjected to alternating Hertzian stresses, including at least one of a rolling contact, a combined rolling and sliding, and an application that requires at least one of a high wear resistance, an increased fatigue, and tensile strength.

15. The system according to claim 1, wherein the part of the lubricant or the part of a new lubricant comprises a fluid lubricant, wherein the fluid lubricant is at least one of: a mineral oil, a synthetic oil, a vegetable oil, a polyalphaolefin, an ester, and a polyether.

16. The method according to claim 8, wherein the part of the lubricant or the part of the new lubricant comprises of a fluid lubricant, wherein the fluid lubricant is at least one of: a mineral oil, a synthetic oil, a vegetable oil, a polyalphaolefin, an ester, and a polyether.
